(19) United States
(12) Patent Application Publication
(10) Pub. No.: US 2017/0027342 A1
(43) Pub. Date: Feb. 2, 2017

(54) Anchorable Beach Towel and Storage Pouch

(71) Applicant: Tasche Towel, LLC, Vienna, VA (US)

(72) Inventor: A.K. Mishra, Vienna, VA (US)

(21) Appl. No.: 15/197,977

(22) Filed: Jun. 30, 2016

Related U.S. Application Data
(60) Provisional application No. 62/197,793, filed on Jul. 28, 2015.

(51) Int. Cl. A47G 9/06; B65D 33/25; H02J 7/00; H02S 10/40; H02J 7/35; E04H 15/62; B65D 85/00

(52) U.S. Cl. CPC A47G 9/062; E04H 15/62; B65D 33/2591; B65D 85/70; H02S 10/40; H02J 7/355; H02J 7/0027

(57) ABSTRACT

A beach towel with reinforced slits and a storage pouch which stores anchoring stakes and other beach accessories is disclosed. The anchoring stakes have a generally round or square tapered elongated body with multiple projections extending transverse to and outwardly from the elongated body which pass through the slits into sand to securely hold the towel from being displaced. When the stakes are removed from the pouch, the pouch can then be used to store cellphones and other personal effects usually brought to the beach. The pouch is designed to be removably attached to the underside of the beach towel for safekeeping of personal effects. Optionally, solar powered charging apparatus for charging cellphones and other electronic devices is stowed in the pouch. Additionally, a method for deploying the beach towel on the sand and an anchorable beach towel kit is disclosed.

### CROSS REFERENCE TO RELATED APPLICATIONS

The present application is a non-provisional application based on and claiming priority from U.S. Provisional Application No. 62/197,793, entitled “Anchorable Beach Towel and Storage Pouch” filed Jul. 28, 2015, the disclosure of which is hereby incorporated herein by reference in its entirety.

### FIELD OF THE INVENTION

The present invention generally relates to beach towels, anchoring stakes for beach towels, and storage means for holding personal effects taken to the beach. More specifically, the present invention relates to a beach towel with lightweight anchoring stakes and an optional portable cell phone charger stored in a storage pouch securable to the beach towel, which can be used to store personal effects of beachgoers when the anchoring stakes are deployed.

### BACKGROUND OF THE INVENTION

A highly popular, enjoyable and relaxing summertime leisure activity is going to the beach. Most people who go to the beach bring a beach towel to spread over the sand. The beach towel, in additional to its use in drying one's body, provides a safe area to place items to protect them from the sand as well as an area for people to sit or lie down without getting an undesired amount of sand on them.

One problem that is associated with typical beach towels is that they often become dislodged from their desired flat placement against the sand due to wind disturbance or people moving around on the towel. For example, gusty winds may result in one or more corners of the beach towel being lifted up, a large portion of the towel being folded over or the entire beach towel being blown away from its desired placement—especially when no one is sitting or lying on the towel. Similarly, movement of people on the towel may cause the towel to bunch-up (i.e., gather into folds) thereby reducing usable surface area and increasing the discomfort of people sitting or lying on the beach towel.

Additionally, such beach towels are also associated with other problems. For example, many people bring personal effects to the beach such as keys, cell phones, cash, credit/debit cards, identification, and other small items. However, there is usually no good place to safely store these personal effects where they are out of view of passers-by, but remain readily accessible whenever they are needed.

Further, beachgoers today frequently use cell phones while at the beach to not only make phone calls and send text messages, but to browse the internet and social media sites. In addition, many beachgoers also bring other portable electronic devices to the beach, such as gaming devices, music players, and e-reading devices, to play games, listen to music, and read digitally downloaded books and/or articles. Quite often cell phones and other portable electronic devices run out of battery power while at the beach and need to be recharged. However, a problem exists in that beaches usually lack a convenient, nearby electricity power source to permit charging of cell phones and other portable electronic devices.

Prior attempts have been made to solve one or more of these problems. Examples of attempts to securely anchor beach towels to a sand surface are referenced in several patent documents, including U.S. Pat. No. 5,101,525; U.S. Pat. No. 6,226,813; U.S. Pat. No. 6,631,527; U.S. Pat. No. 6,938,384; U.S. Pat. No. 8,146,183; U.S. Pat. No. 8,327,476; and U.S. Pat. Pub. No. 2005/0005355, the entire disclosures of which are incorporated herein by reference. Similarly, examples of attempts to provide safe storage for personal effects are referenced in several other patent documents, including U.S. Pat. No. 6,192,536; U.S. Pat. No. 8,959,679; and U.S. Pat. Pub. No. 2005/0217048, the disclosures of which are incorporated herein by reference in their entireties. Additionally, an example of an attempt to provide for cell phone charging is referenced in U.S. Pat. Pub. No. 2014/0231277. The disclosure in this publication is also incorporated herein by reference in its entirety.

While the devices described in the aforementioned prior art patents and publications may fulfill their stated objectives to some extent, none of the devices provides a beach towel that combines a storage means for storing anchoring stakes when not deployed and a temporary storage means for storing personal effects and/or optional electronic device charging apparatus when anchoring stakes are deployed. Accordingly, there exists a need for an improved beach towel with all the benefits described above.

### SUMMARY OF THE INVENTION

The present invention substantially departs from the conventional solutions of the prior art and fulfills all the above needs by providing a beach towel including the following features: (a) a set of anchoring stakes/pegs for securely holding the beach towel at a desired location on a sand surface, particularly a sandy beach; (b) an optional charging apparatus usable for recharging cell phones and other portable electronic devices brought to the beach; and (c) a storage pouch attachable to the beach towel for (i) storing the set of anchoring stakes/pegs when not deployed to hold the beach towel, and (ii) temporarily storing the personal effects/items of beachgoers when the anchoring stalks/pegs are deployed to secure the beach towel and the optional cell phone/electronic device charging apparatus when it is not being utilized for charging purposes.

To achieve these objectives, it is an object of the present invention to provide a beach towel adapted for beneficial deployment on a beach, particularly a sandy beach surface.

It is another object of the present invention to provide an anchored down beach towel in which each corner includes structure thereon for removably securing the beach towel on a sand surface in a taut and wind resistant manner.

It is yet another object of the present invention to provide a beach towel having reinforced apertures adjacent its perimeter edge to permit anchoring stakes to extend through the apertures into sand to securely hold the beach towel firmly to a sand beach surface.

It is a further object of the present invention to provide improved anchoring stakes for securing a beach towel to a sand beach surface to prevent it from being adversely affected by wind gusts or movement of people on the beach towel.

It is an additional object of the present invention to provide an anchored beach towel having a set of removable stakes designed to extend through holes in the periphery of the beach towel to securely position it on a sand surface so it is resistant to displacement by wind disturbance and movement of people sitting, standing or reclining on the beach towel.

It is still another object of the present invention to provide a plurality of anchoring stakes having outwardly extending tapered projections to enhance anchoring and securement of the stakes to sand.

It is yet another object of the present invention to provide a plurality of tapered anchoring stakes having a multiple array of outwardly extending teeth, spikes or wedge-shaped flanges or protrusions designed to enhance anchoring and securement of the stakes to sand and resist inadvertent pulling out of the stakes from the sand.

It is still a further object of the present invention to provide a beach towel having an attached removable storage pouch to store anchoring stakes when not deployed to hold the beach towel to a sand surface; personal effects of beachgoers when the anchoring stakes are deployed to hold the beach towel to a sand surface; and optional cell phone/electronic device charging apparatus when it is not being utilized for charging purposes.

One aspect of the present invention is to provide an improved method of anchoring a beach towel to a sand surface employing a set of tapered stakes extending through holes formed in the periphery of the beach towel to securely hold it to the sand surface so it will not be adversely affected by wind gusts or people moving around on the towel; storing personal effects in a storage pouch; and attaching the storage pouch to the bottom of the beach towel so it is out of sight of passers-by to prevent theft of personal effects.

Another aspect of the present invention is to provide a beach towel and a storage pouch having attachment structure permitting the storage pouch to be removably attached to the underside of the towel when it is deployed on a sand surface to provide secure containment and protection for personal effects out of sight of passers-by.

Yet a further aspect of the present invention is to provide an anchorable beach towel kit with multiple components including a beach towel, a set of anchoring stakes, a storage pouch, an instruction sheet and, optionally, a portable solar powered battery charging apparatus.

In one embodiment of the present invention, a portable battery charging apparatus is provided for charging cell phones, as well as other portable electronic devices, using solar energy. When the charging apparatus is not being utilized to harness sunlight for charging purposes, it may be stored in a storage pouch removably attached to a beach towel.

In yet another embodiment of the present invention, a portable solar energy powered battery charging apparatus is temporarily positioned on the top side of a beach towel while a cell phone or another electronic device is securely stored in a removable storage pouch attached to the underside of the towel during a charging operation to keep the cell phone, as well as any electronic devices, hidden from view of passers-by to prevent pilferage.

Other aspects and advantages of the present invention will become apparent to those skilled in the art on reviewing the drawings referenced below and reading the following detailed description.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein like components are designated by like reference numerals.

FIG. 1 is an exploded perspective view illustrating a beach towel, a set of exemplary anchoring stakes/pegs, and a storage pouch in accordance with the present invention.

FIG. 2 is a perspective view from above, right, illustrating the beach towel of FIG. 1 fully opened on a sand surface with the anchoring stakes of FIG. 1 fully inserted into the sand in accordance with the present invention.

FIG. 3 is a perspective view from below, right, illustrating the bottom side of the beach towel of FIG. 1 with the button fasteners for attaching the storage pouch of FIG. 1 to the beach towel according to the present invention.

FIG. 4 is an enlarged exploded and partial perspective view from below, right, diagrammatically illustrating engagement of the storage pouch of FIG. 1 to the button fasteners on the bottom side of the beach towel of FIG. 1 according to an aspect of the present invention.

FIG. 5 is a perspective view from above, right of the beach towel of FIG. 1 illustrating the anchoring stakes of FIG. 1 prior to insertion through the holes in the beach towel and the storage pouch of FIG. 1. (shown in phantom) attached adjacent one of the side edges of the beach towel in accordance with the present invention.

FIG. 6 is a perspective view from above, right, of the beach towel of FIG. 1 showing in phantom alternative attachment locations for attaching the storage pouch of FIG. 1 to the bottom side of the beach towel in accordance with the present invention.

FIG. 7 is an enlarged partial perspective view from above, right, illustrating the stitching reinforcing the elongated opening in a corner of the beach towel of FIG. 1 in accordance with an aspect of the present invention.

FIG. 8 is a partial perspective view from above, right, illustrating the beach towel of FIG. 1 with optional cell phone/electronic device charging apparatus positioned on the top of the beach towel and a cell phone (shown in phantom) stored in the storage pouch of FIG. 1 (shown in phantom) connected to the charging apparatus by an adapter cable in accordance with an aspect of the present invention.

FIG. 9 is a perspective view from above, right, illustrating the beach towel of FIG. 1 in a folded storage/transport configuration with the storage pouch and anchoring stakes of FIG. 1 (shown in phantom) stored in the pouch according to an aspect of the present invention.

FIG. 10A is a plan view illustrating the front side of the storage pouch of FIG. 1 according to an aspect of the present invention.

FIG. 10B is a plan view illustrating the rear side of the storage pouch of FIG. 1 according to an aspect of the present invention.

FIG. 11A is a side elevation view illustrating the preferred anchoring stake shown in FIG. 1.

FIG. 11B is a top view in plan of the stake of FIG. 11A.

FIG. 11C is a view in section taken along section line A-A of FIG. 11A.

FIG. 11D is a perspective view from above, right, of the anchoring stake of FIG. 11A.

FIG. 12A is a side elevation view illustrating an alternative anchoring stake suitable for engaging the beach towel of FIG. 1.

FIG. 12B is a top view in plan of the stake of FIG. 12A.

FIG. 12C is a view in section taken along section line B-B of FIG. 12A.

FIG. 12D is a perspective view from above, right, of the anchoring stake of FIG. 12A.

FIG. 13A is a side elevation view illustrating another alternative anchoring stake suitable for engaging the beach towel of FIG. 1.

FIG. 13B is a top view in plan of the stake of FIG. 13A.

FIG. 13C is a view in section taken along section line C-C of FIG. 13A.

FIG. 13D is a perspective view from above, right, of the anchoring stake of FIG. 13A.

FIG. 14A is a side elevation view illustrating a further alternative anchoring stake suitable for engaging the beach towel of FIG. 1.

FIG. 14B is a top view in plan of the stake of FIG. 14A.

FIG. 14C is a view in section taken along section line D-D of FIG. 14A.

FIG. 14D is a perspective view from above, right, of the anchoring stake of FIG. 14A.

FIGS. 15A-15C are cross-sectional views illustrating respective sequential steps of anchoring the beach towel of FIG. 1 to a sand surface utilizing the anchoring stake of FIGS. 11A-11D in accordance with an aspect of the present invention.

FIG. 16 is a perspective view from above, right, illustrating an anchorable beach towel kit comprising a beach towel, a set of anchoring stakes, a storage pouch, an instruction sheet, and an optional portable solar powered battery charging apparatus in accordance with an aspect of the present invention.

### DETAILED DESCRIPTION OF THE INVENTION

It is intended that the description below not be limited to terms of orientation that are used for convenience and ease of understanding. Specifically, it is to be understood that terms such as “top”, “bottom”, “front”, “rear”, “side”, “length”, “width”, “transverse”, “upper”, “lower”, “interior”, “exterior”, “inner”, “outer” and the like as may be used herein, merely describe points of reference and do not limit the present invention to any particular orientation or configuration.

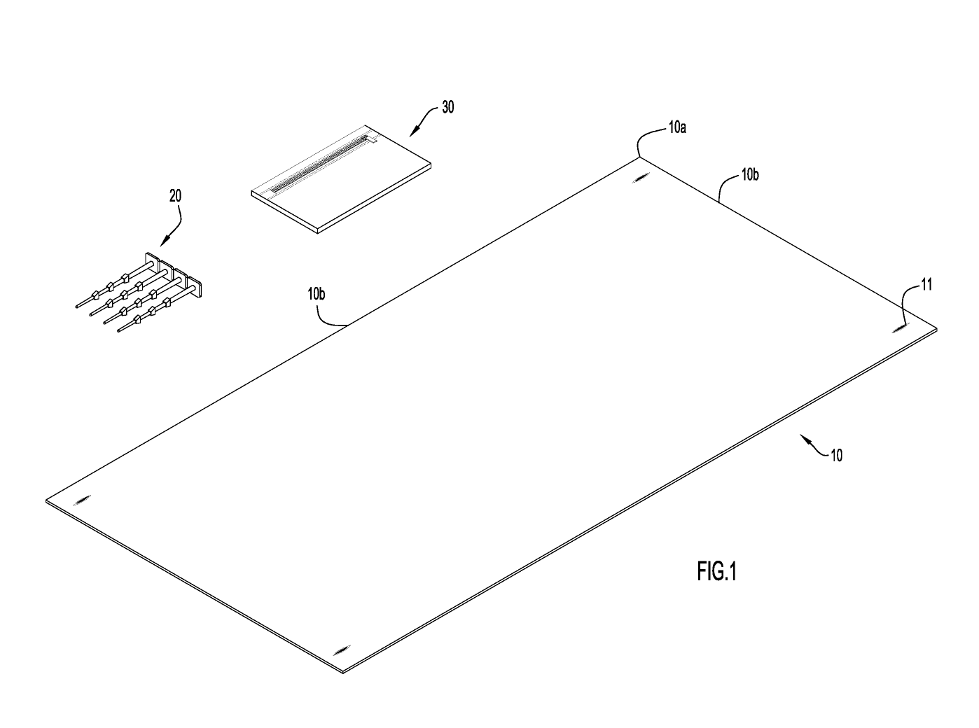

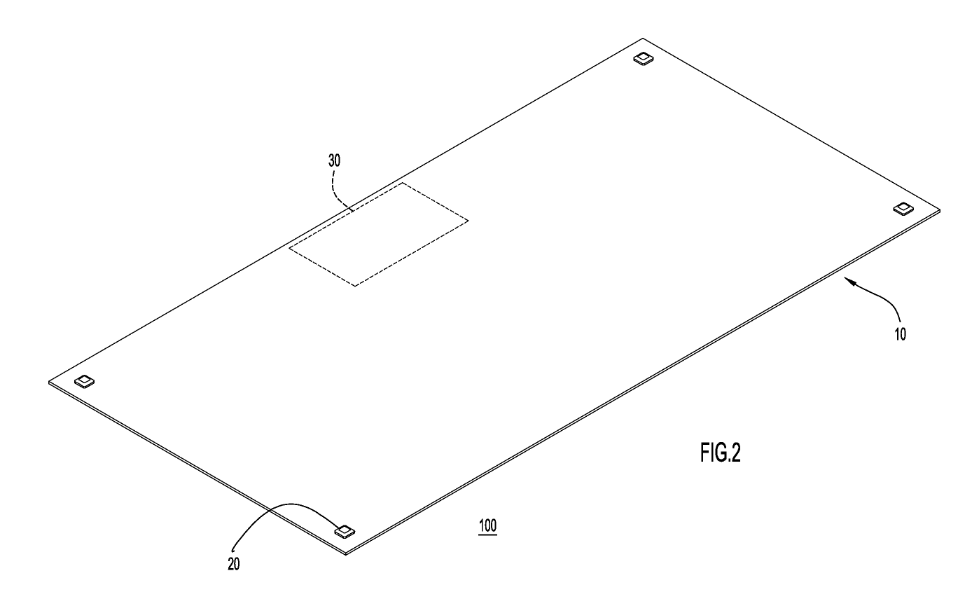

In accordance with the principles of the present invention, FIG. 1 illustrates a beach towel 10 having a plurality of apertures or holes 11 formed therethrough, a set of anchoring stakes/pegs 20 to secure the beach towel to a sand surface, and a storage pouch 30 for storing stakes 20 when not deployed to secure beach towel 10 to a sand surface; while FIG. 2 illustrates beach towel 10 as it is disposed for use on sand 100, particularly a sandy beach surface. The beach towel 10 may be of any suitable shape and size, but is preferably of rectangular shape and sized for use by a single/individual person. Typically, beach towel 10 has a size of about 3 ft. by 6 ft.; however, the size of the towel may be increased, if desired, to provide a larger surface area for one or more persons sitting and lying on sand surface 100. Further, users (e.g., beachgoers) may easily place two smaller beach towels 10 together, with edge-to-edge disposition and shared anchoring stakes/pegs 20, to create an even larger surface area.

As further shown in FIG. 1, beach towel 10 of the present invention is relatively thin (i.e., the thickness of a typical towel) and shaped as a rectangle with four corners 10a and four side edges 10b. The beach towel 10 may be composed of machine washable fabric material, such as cotton terry, preferably of various colors. However, the fabric material may include a decorative design, such as a pattern of varying lines, shapes and/or colors (not shown) to provide the beach towel with a more distinctive appearance. Further, the beach towel 10 may have a conventional hem (not shown) sewn about its side edges 10b to prevent fraying of the fabric material. The portions of the beach towel adjacent side edges 10b generally define an outer periphery of the beach towel.

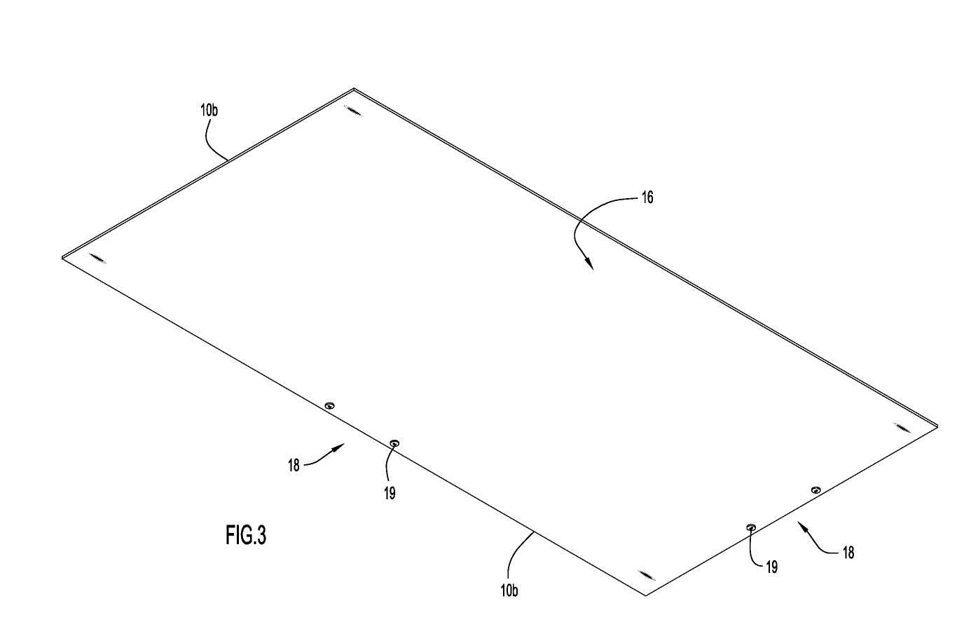

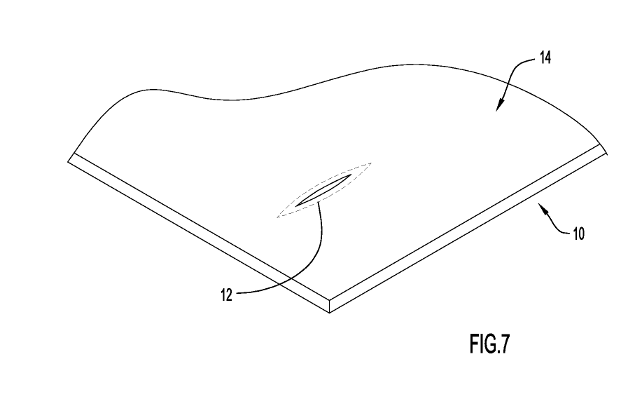

Preferably, an aperture or hole 11 is formed through the fabric material of beach towel 10 at each corner 10a. Each aperture is positioned inward of side edges 10b of the beach towel and is preferably (but not necessarily) a narrow, elongated slit (e.g., buttonhole configuration) formed through the fabric material (see FIGS. 1 and 3). The edges of the fabric material adjacent slits (holes) 11 are preferably reinforced by cotton or polymer stitching 12 such as, for example, one or more rows of straight or zig-zag stitches which surround the slit to strengthen the hole periphery and prevent the fabric material from tearing (see FIG. 7). Alternatively, slits (holes) 11 may be reinforced by surrounding the edges of the slits by looped threads (not shown) or by stitching an additional piece of cloth fabric around the slits (not shown). The added cloth fabric provides extra strength to prevent tearing of the fabric material surrounding the slits when the beach towel 10 is subjected to pulling forces in use or by persons moving on the towel or by strong, gusty wind conditions.

As mentioned above, the apertures (holes) 11 extending through the fabric material at corners 10a of beach towel 10 may have different configurations. For instance, holes 11 may have circular or oval configurations (not shown). Although reinforcement by stitching is preferred, any other suitable reinforcement means may be utilized to prevent tearing of the fabric material surrounding holes 11. For example, the edges of the fabric material adjacent the aforementioned circular or oval shaped apertures/holes may be reinforced by a correspondingly similar shaped grommet (not shown). If grommets are utilized to reinforce the fabric material, they should be made from a relatively rigid material that will not rust upon exposure to moisture, such as non-corrosive metal or plastic material. In addition, depending upon the size of beach towel 10, further apertures or holes 11 may be provided, as needed, at other locations adjacent the outer periphery of the beach towel to insure that it remains securely affixed to the sandy beach surface (i.e., sand) during movement of people on top of the towel or during gusty wind conditions.

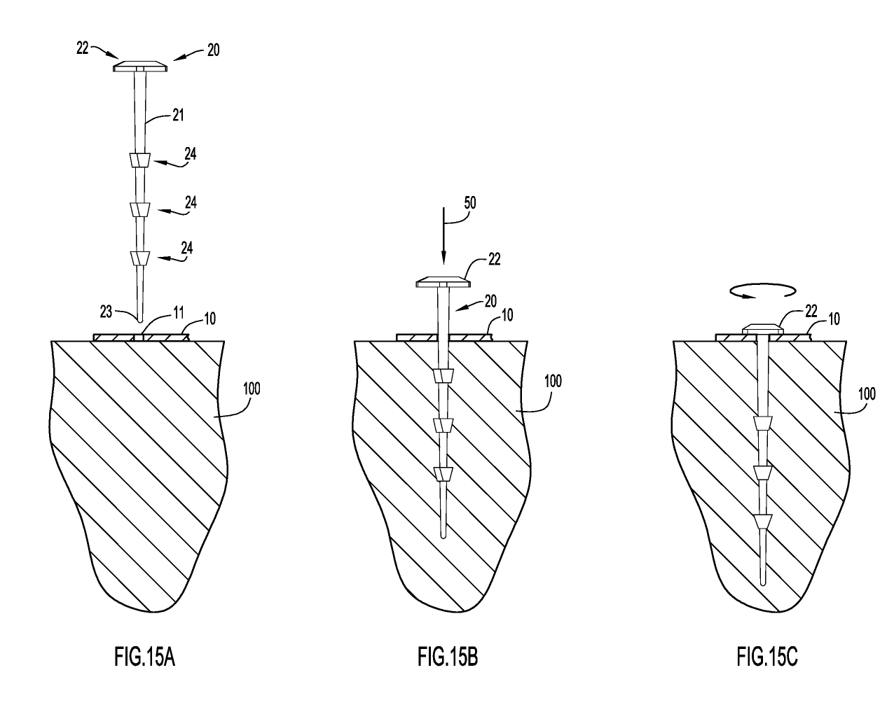

With further reference to FIGS. 1-6, the beach towel 10 has a top side (surface) 14 and a bottom side (surface) 16. As shown in FIGS. 1, 2 and 5, a set of anchoring stakes/pegs 20 is provided to hold the beach towel securely to sandy beach surface (sand) 100. A user (e.g., a beachgoer) usually inserts anchoring stakes 20 through respective apertures (holes) 11 located at corners 10a of the beach towel 10 and pushes downward on the stake until it is fully seated in the sand (see FIGS. 15A-15C). Normally, stakes 20 are fully seated in the sand by users (beachgoers) pushing or pressing downward on each stake with the palm of their hand. Optionally, users may press (push) downward on stakes 20 with the heel of their foot until each stake is fully seated in the sand 100 or, if available, beachgoers may use a mallet (not shown) to hammer each stake or peg into the sand until a head of the stake is flush to the surface of sand 100.

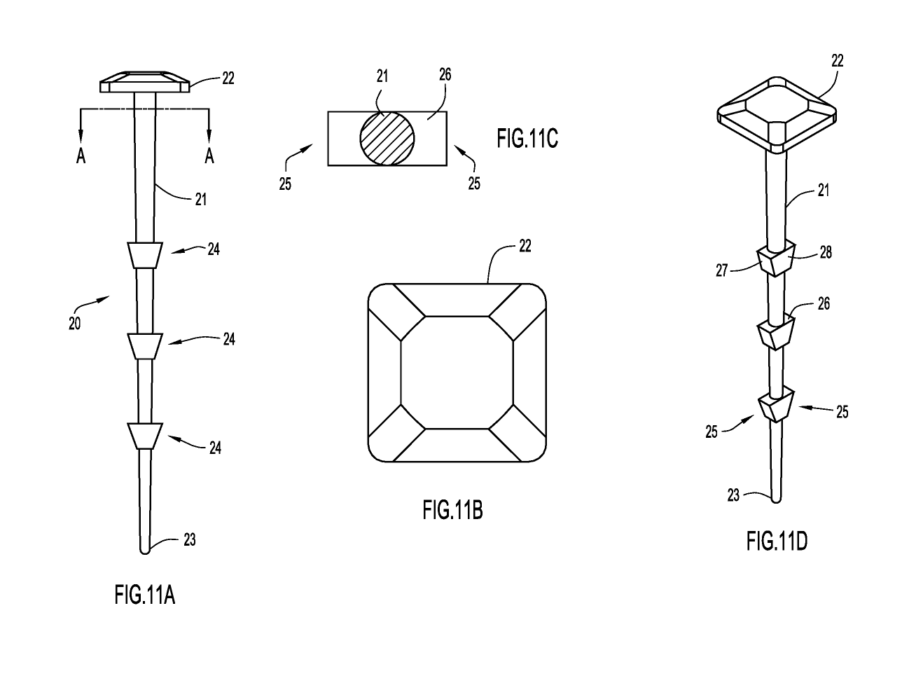

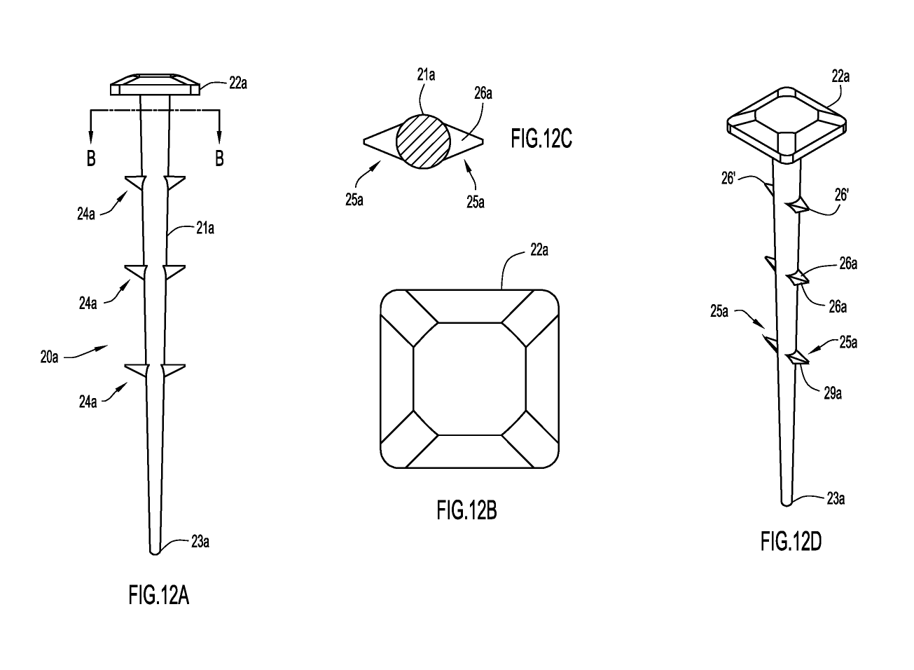

As will be explained in more detail below, each anchoring stake 20 has a generally elongated body 21 with multiple axially spaced projections 24 (FIG. 11A, as well as FIGS. 12A, 13A, and 14A) that positively engage sand 100 (FIGS. 15B-15C) to enhance anchoring and securement of the stake relative to beach surface 100 and make it more difficult for a wind generated lifting force acting on beach towel 10 to lift it from sand surface 100 once it is fully seated. In addition, multiple projections 24 reduce the possibly that stakes 20 will inadvertently be pulled from the sand by movement of people on the beach towel.

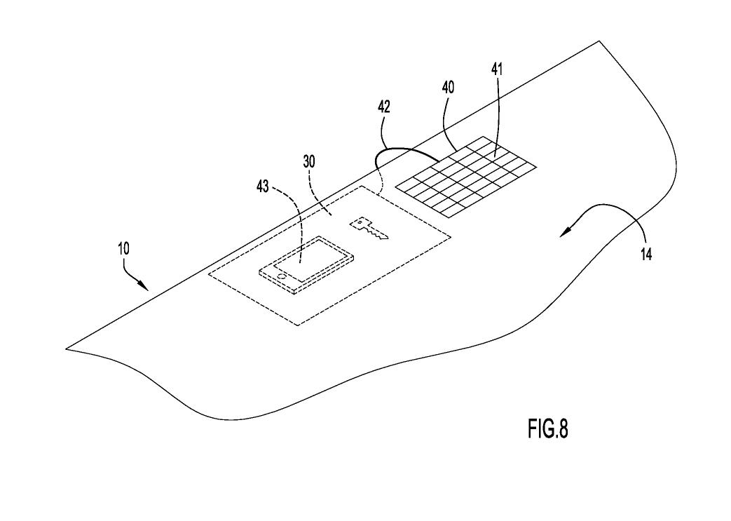

Referring to FIG. 8, an optional electronic device charging apparatus 40 capable of recharging batteries of portable electronic devices, such as cell phones, iPads®, smartphones, MP3 Players, tablets, e-Readers and the like, is shown positioned on the top side 14 of beach towel 10. The electronic device charging apparatus 40 is preferably (but not necessarily) a portable solar charging assembly having a photovoltaic array of solar cells 41 which receives solar energy emitted by the sun and converts the solar energy into stored voltage to provide electrical power. The solar charging assembly may include at least one power cable 42 for electrically connecting the solar charging assembly with any of the exemplary types of portable electronic devices mentioned above. See exemplary cell phone 43 shown in phantom in FIG. 8.

Moreover, since many of the above mentioned exemplary electronic devices, especially cell phones and smartphones, may have differently configured charging ports, charging apparatus 40 may optionally be provided with a plurality of auxiliary plug adapters (not shown) to insure the solar charging assembly will be compatible with as many cell phones and portable electronic devices as possible. Examples of suitable portable solar changing assemblies which may be employed with the beach towel of the present invention are disclosed in the following U.S. patent publications: U.S. Pat. Pub. 2009/0007958 to Ho et al.; U.S. Pat. Pub. 2001/0095719 to Strickland; and U.S. Pat. Pub. 2013/0162193 to Quick et al., the disclosures of which are incorporated herein by reference in their entirety.

Alternatively, other optional electronic device charging apparatus 40 employable with the beach towel of the present invention may include, for example, portable battery chargers of the type disclosed in U.S. Pat. Pub. 2007/0063669 to Keating, the disclosure of which is incorporated herein by reference it its entirety. In addition, any suitable commercially available universal portable battery powered charger may be used as well. An example of a commercially available battery powered charger suitable for use with the beach towel of the present invention is the RAVPower 7800 mAh Power Bank External Battery Pack (2.4 A Output, 2 A Input, Deluxe Series, iSmart Technology) for iPhone, iPad, Android, Windows smartphones, tablets and more.

Again referring to FIG. 8, exemplary cell phone 43 (shown in phantom) may be electrically connected to charging apparatus 40 by power cable 42 while the cell phone is stored in removable storage pouch 30 (shown in phantom) attached to the bottom side 16 of the beach towel. Additionally, whenever electronic device charging apparatus 40 is not being used to harness solar energy emitted by the sun for charging purposes, it may be stored in removable storage pouch 30 as well. These features of the present invention will be described in more detail below.

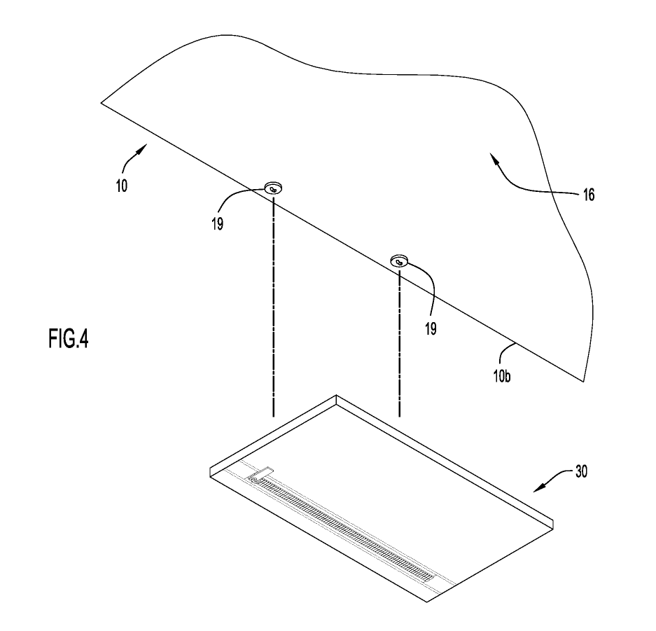

As best seen in FIGS. 3-4, beach towel 10 also includes attachment means 18 on its bottom side 16 to permit storage pouch 30 to be removably attached to the beach towel. The attachment means 18 may be installed at any location along the outer periphery of the beach towel adjacent its side edges 10b. In a preferred embodiment of the present invention, the attachment means 18 may be a pair of spaced apart buttons 19 (see FIG. 4) secured to bottom side 16 of beach towel 10 by thread, e.g., colored thread matching the color of the cotton terry fabric. In FIGS. 3-4, buttons 19 are shown attached along the outer periphery of the rectangular shaped beach towel at locations set back (i.e., spaced inward) from its long and short side edges 10b. Preferably, however, buttons 19 are attached to the outer periphery of the beach towel 10 at locations spaced inward from only one of these side edges 10b (i.e., either the long side edge or the short side edge). Optionally, the attachments means 18 may comprise small patches of hook-and-loop-type material (Velcro®), snaps or a buckle-type clasp, as will be described in more detail below.

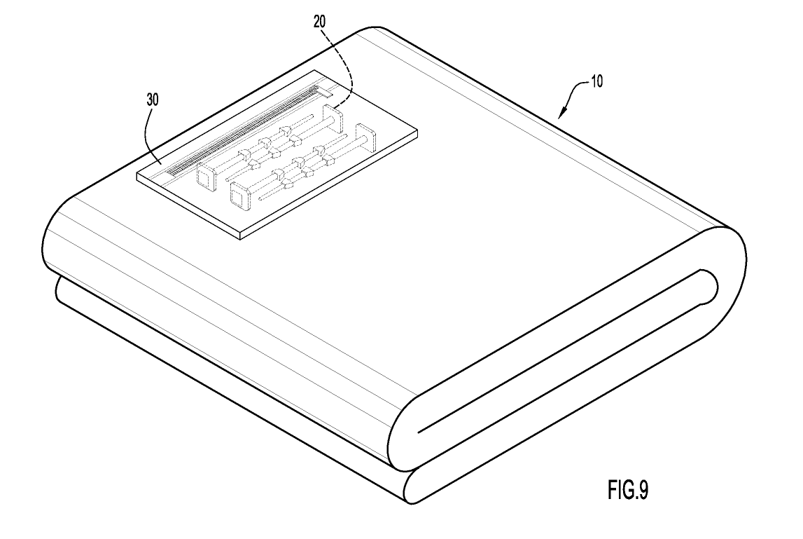

In FIG. 9, beach towel 10 is shown in a square or rectangular transport/storage configuration. As may be readily seen, anchoring stakes 20 are stored in storage pouch 30 when the beach towel is in its transport/storage configuration. If included, electronic device charging apparatus 40 (e.g., a cell phone charger) may also be stored in the storage pouch. While storage pouch 30 may be of various sizes, it should at least have a minimum width and length dimension large enough to accommodate a set of stakes 20 corresponding to the number of apertures or holes 11 extending through beach towel 10, as well as electronic device charging apparatus 40 (if included). In the present invention, the storage pouch preferably is approximately 8 inches by 14 inches.

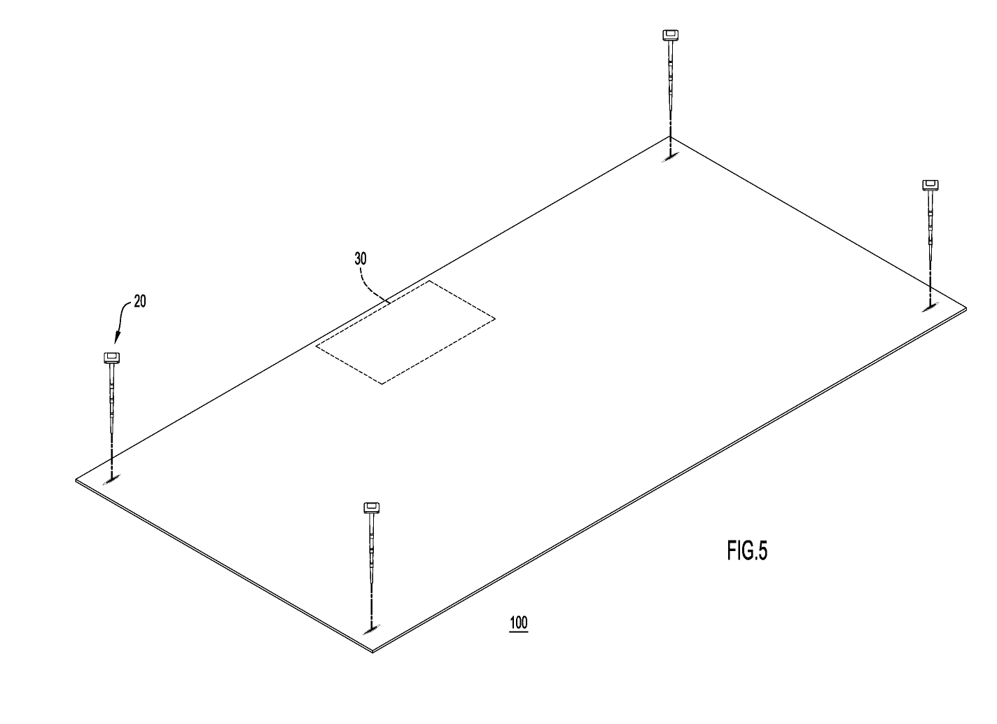

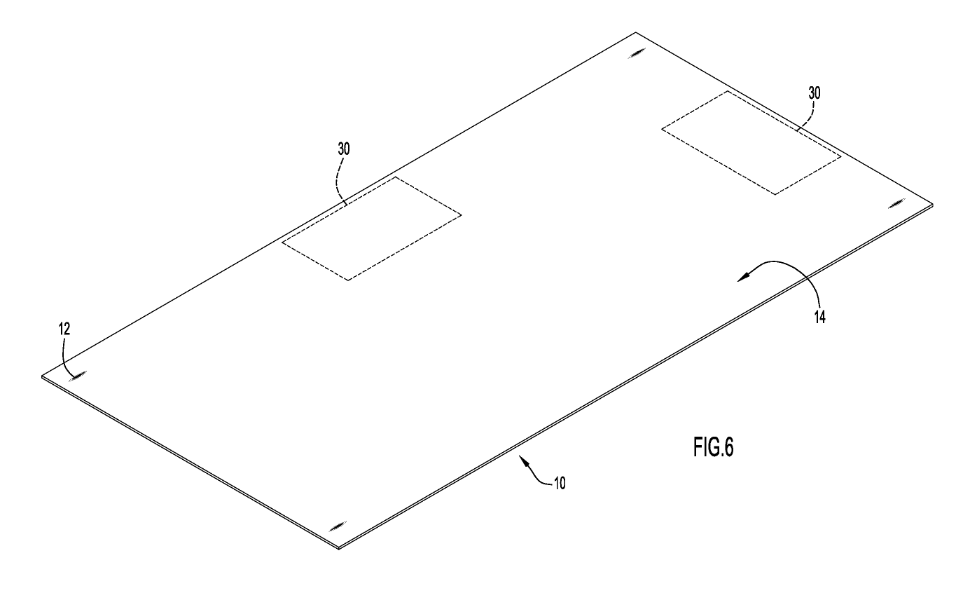

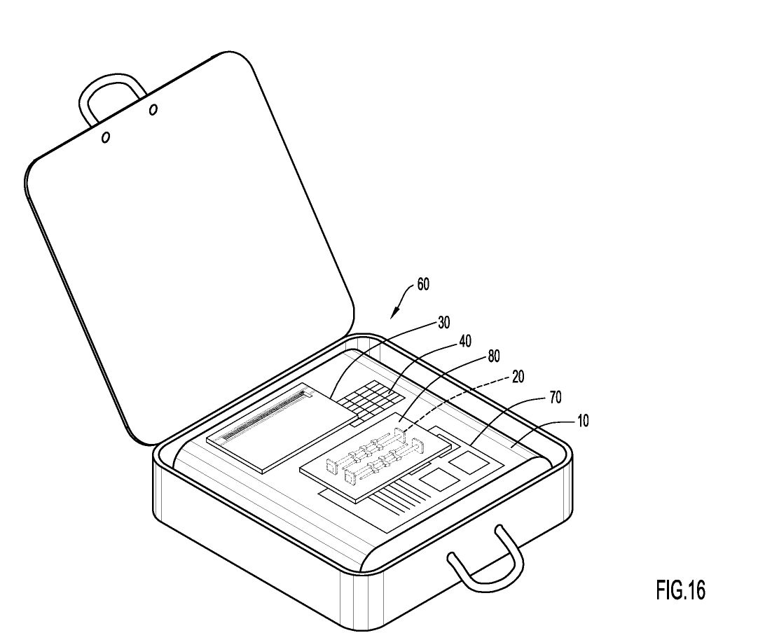

As mentioned above, storage pouch 30 may be attached to beach towel 10 adjacent one or more of its side edges 10b (see FIGS. 5-6). However, when storage pouch 30 is positioned adjacent the short side edge of the beach towel (e.g., adjacent a bottom edge as shown in FIG. 4), it allows the beach towel to be rolled-up into a cylindrical transport/storage configuration (not shown) and, when storage pouch 30 is positioned adjacent the long side edge of the beach towel (e.g., the right or left side edge as shown in FIG. 5), it permits the beach towel to be folded-up into its square or rectangular transport/storage configuration shown in FIG. 9 so that the beach towel may be carried to and from the beach within a soft carrying case 60 (FIG. 16), preferably a two-handled, soft plastic or canvas tote bag having its access opening closed by a conventional zipper or other suitable fastening device (not shown). To pack the beach towel 10 for transport after use, the personal effects such as keys and cell phones (shown in phantom in FIG. 8) are removed from storage pouch 30, the anchoring stakes 20 are pulled from the sand and stored in the pouch and, if included, the cell phone charger 40 is stowed and retained in the pouch as well. Thereafter, storage pouch 30 is installed at one of the specified locations adjacent the side edges 10b of the beach towel and the towel rolled or folded.

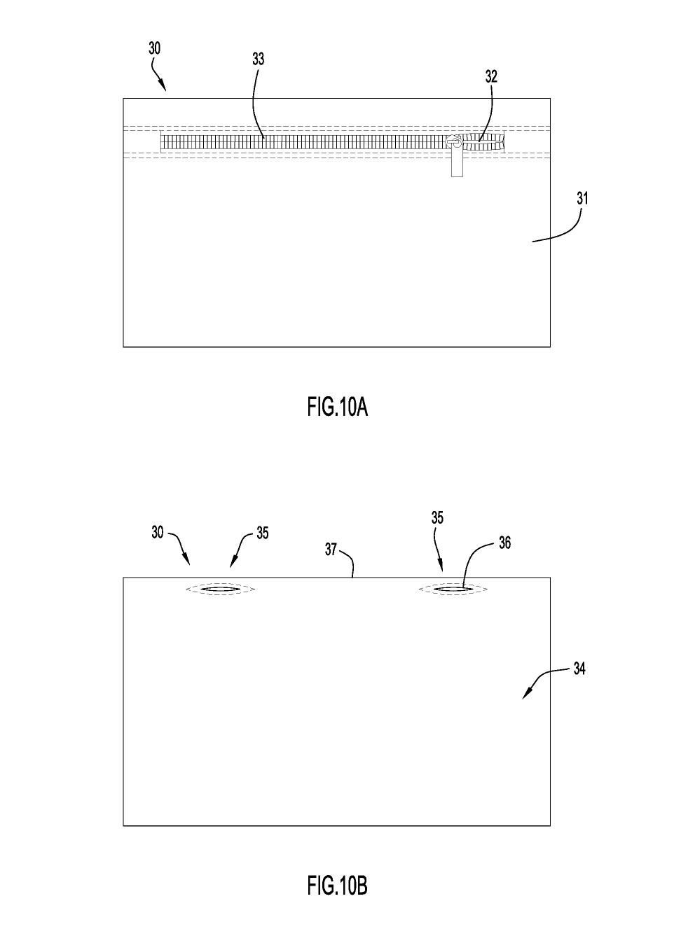

An exemplary storage pouch 30 is illustrated in more detail in FIGS. 10A-10B. The storage pouch is formed in rectangular shape although any geometric shape may be used. As shown in FIG. 10A, a front side (panel) 31 of the storage pouch has a narrow, elongated opening 32 to permit access to the pouch's interior. In order to retain anchoring stakes or pegs 20, personal effects of a beachgoer (represented by a cell phone and a key shown in phantom in FIG. 8), and electronic device charging apparatus 40, if included, securely within pouch 30, the pouch opening 32 is provided with a closure member, preferably a zipper 33, which may be selectively opened and closed. However, any other suitable closure means may be utilized to tightly close opening 32, for example, snaps and hook-and-loop-type fasteners (not shown). Moreover, as mentioned above, when exemplary cell phone 43 is being charged while stored in pouch 30, power cable 42 may be fed through partially unzipped opening 32 or through another closable opening in the pouch provided for this specific purpose (not shown).

Furthermore, storage pouch 30 may be made of a durable, washable, water resistant or waterproof, flexible fabric material to protect the personal effects of users (beachgoers), as well as charging apparatus 40 (if included) from being damaged by water or moisture infiltration. For example, the pouch is fabricated from, but not limited to, a flexible fabric material that has a soft synthetic fabric side and a waterproof side, such as a waterproof coating. Optionally, the storage pouch 30 may further include one or more internal divider panels (not shown) in its interior to provide compartments to kept personal items/belongings of beachgoers, as well as the anchoring stakes, separate from charging apparatus 40 (if included). The internal divider panels may be made from a durable, washable, water resistant or waterproof, flexible fabric material as well. The internal divider panels essentially preclude migration of water or moisture between compartments.

Referring now to FIG. 10B, a back side (panel) 34 of storage pouch 30 has a fastening mechanism 35 for removably attaching the pouch to the bottom (back) side 16 of beach towel 10. The fastening mechanism 35 is preferably (but not necessarily) a pair of spaced apart narrow openings (i.e., slits or buttonholes) 36 extending through back panel 34 into the interior of storage pouch 30. The slit (buttonhole) openings 36 extend substantially parallel to an upper edge 37 of the storage pouch at locations adjacent the upper edge. The slits (buttonholes) 36 have a length dimension sized to accommodate buttons 19 attached to the bottom side 16 of beach towel 10. Moreover, slit openings 36 are spaced apart a distance which corresponds to a distance buttons 19 are spaced apart on the bottom side 16 of beach towel 10. Additionally, in order to assure that storage pouch 30 will not be seen by passers-by when it is secured to back side 16 of beach towel 10, each slit opening 36 is set back (i.e., spaced inward) from upper edge 37 a distance that is equal to or less than a distance that buttons 19 are set back (i.e., spaced inward) from the side edges 10b of the beach towel. For example, each slit opening 36 may be set back from upper edge 37 approximately 0.5 inches, while each button 19 may be set back from side edges 10b approximately 0.5 inches to 1.0 inches. Moreover, as discussed above with respect to slit openings 11 in beach rowel 10, slit openings 36 in back panel 34 of storage pouch 30 may be reinforced with stitching in a manner similar to that described for slit openings 11 (see FIG. 10B).

While a preferred embodiment of the present invention may use a pair of buttons 19 to fasten storage pouch 30 to bottom (back) side 16 of beach towel 10, as discussed above, any suitable alternative fastener may be used, e.g., hook-and-loop-type fasteners (Velcro®), snaps or buckle-type clasps. Specifically, if hook-and-loop-type fasteners are used to attach the storage pouch 30 to bottom side 16 of beach towel 10, attachment means 18 may be the loop portion of the hook-and-loop-type fastener while fastening mechanism 35 may be the hook portion of the fastener. Similarly, if snaps are used to attach the storage pouch to the beach towel, attachment means 18 may be the female part of the snap and fastening mechanism 35 may be the male part of the snap. Likewise, if a buckle-type clasp is used to attach the storage pouch to the beach towel, attachment means 18 may be the strap portion of the buckle-type clasp while fastening mechanism 35 may be the buckle portion of the buckle-type clasp. Moreover, each noted alternative fastening mechanism 35 would be similarly set back from upper edge 37 of storage pouch 30 a distance equal to or less than alternative attachment means 18 is set back from side edges 10b of beach towel 10 in order to assure that storage pouch 30 will not seen by passers-by when it is secured to the bottom or back side 16 of the beach towel.

As discussed in more detail below, differently configured anchoring stakes/pegs may be utilized to secure beach towel 10 to sand 100. As shown in FIGS. 11A-11D, anchoring stake 20 includes a generally round, elongated body 21 having an enlarged head 22 at one end (see FIG. 11B, as well as FIG. 11D). Moreover, the elongated body 21 tapers axially from enlarged head 22 to a generally pointed opposite end 23 for ease of axial insertion of stake 20 through openings 11 into sand 100 (see FIGS. 15A-15C). However, the generally pointed opposite end 23 may be configured as a smoothly rounded end since rounded ends are less likely to hurt or injure a user (beachgoer). The stake 20 (as well as the other differently configured stakes to be described in detail below) is fabricated from lightweight material such as, but not limited to, plastic, composite or corrosive-resistant metal material and is approximately eight to nine inches long. The enlarged head 22 is preferably integrally molded to elongated body 21 and has a generally square truncated pyramidal shape with smooth contoured edges (FIG. 11D). However, the enlarged head may have any other desirable geometric shape. The over-sized head 22 extends transversely (e.g., perpendicularly) outward from elongated body 21 to not only hold and stabilize the beach towel against sand 100, but prevent corners 10b of the beach towel from slipping past head 22 in gusty wind conditions or upon movement of people on the beach towel. Moreover, due to head 22 being oversized, a user (beachgoer) only has to press downward on the top surface of head 22 with the palm of his/her hand to fully drive or seat stake 21 into sand 100 (see FIG. 15B wherein arrow 50 is representative of a users' palm applying a downward force to the top surface of oversized head 22).

As further shown in FIGS. 11A and 11D, anchoring stake 20 has a plurality of projections 24 spaced axially apart which are preferably molded to the outer surface of elongated body 21. While three axially spaced apart projections 24 are shown (see FIG. 11A), it is envisioned that more or fewer projections may be molded or otherwise secured to elongated body 21. Also, while the projections are preferably spaced approximately 1¼ inches apart, any other suitable spacing may be employed. Further, each projection 24 is configured as a downward tapering solid trapezoid comprising a pair of diametrically 180° opposed generally flange-like protrusions 25 each extending transverse to and perpendicularly outwardly from the tapered cylindrical outer surface of elongated body 21. The generally flange-like protrusions have a top surface configured as a wide, flat shoulder 26 facing upward (i.e., toward the underside of the enlarged head 22) and an outer surface 27 which gradually tapers or converges from an outmost edge of each shoulder to intersect with the outer surface of elongated body 21. In addition, each protrusion 25 has opposing flat, side surfaces 28 which are flush to the outer surface of elongated body 21. The protrusions 25 are designed such that tapered outer surfaces 27 permit stake 20 to be easily inserted into sand 100 by pressing (pushing) down with the palm of a hand, while the wide, flat shoulders 26 enhance anchoring and securement of the stake to the sand by resisting inadvertent upward movement or pulling out of the stake from the sand. Moreover, each projection 24 has a maximum length dimension extending between outmost edges of opposed protrusions 25 which is less than the length dimension of slit openings 11 in beach towel 10 such that it may be aligned with the slit openings and easily passed therethrough into sand 100 during insertion of the stake for anchoring the beach towel in place.

Referring to FIGS. 12A-12D, an alternative anchoring stake 20a for use with beach towel 10 of the present invention will now be described. Alternative anchoring stake 20a is similar to anchoring stake 20 in that it has a round, elongated body 21a that tapers axially from enlarged head 22a to a generally pointed opposite end 23a for ease of axial insertion of stake 20a through openings 11 into sand 100 (see FIGS. 15A-15C). In like manner, the generally pointed opposite end 23a may be configured as a smoothly rounded end as noted above. However, alternative anchoring stake 20a differs from anchoring stake 20 in that each axially spaced apart projection 24a is spaced slightly closer to enlarged head 22a than each projection 24 is spaced to enlarged head 22 and comprises a pair of diametrically opposed generally triangular pyramidal shaped spikes or teeth 25a each extending transverse to and outwardly from the outer surface of elongated body 21a (see FIG. 12A, as well as FIGS. 12C-12D). Further, each spike/tooth 25a has three flat, triangularly shaped outer faces 26a (only two shown in FIG. 12D) which merge to a pointed outer end 26′. One of the triangularly shaped outer faces 26a is oriented to face upward (i.e., toward the underside of enlarged head 22a), while each of the two other triangularly shaped outer faces 26a are inclined downwardly from an outer edge of the one outer face to form a downwardly facing edge 29a (see FIG. 12D). Additionally, each spike 25a has a width dimension at its base that is less than the diameter of elongated body 21a at its respective axial location (see, for example, FIG. 12C). Furthermore, spikes 25a are designed such that inclined outer faces 26a, as well as the downwardly facing edge 29a, permit stake 20a to be easily inserted axially into sand 100 by pressing (pushing) down with the palm of a hand, while the flat, triangularly shaped outer face 26a oriented toward the underside of enlarged head 22a enhances anchoring and securement of the stake to the sand by resisting inadvertent upward movement or pulling out of the stake from the sand. Moreover, as discussed with respect to anchoring stake 20, stake 20a is also designed such that projections 24a have a maximum length dimension extending between pointed outer ends 26′ of opposed spikes 25a that is less than the length dimension of slit openings 11 in beach towel 10 so projections 24a may be aligned with the slit openings and easily passed therethrough into sand 100 during insertion of the stake for anchoring the beach towel in place.

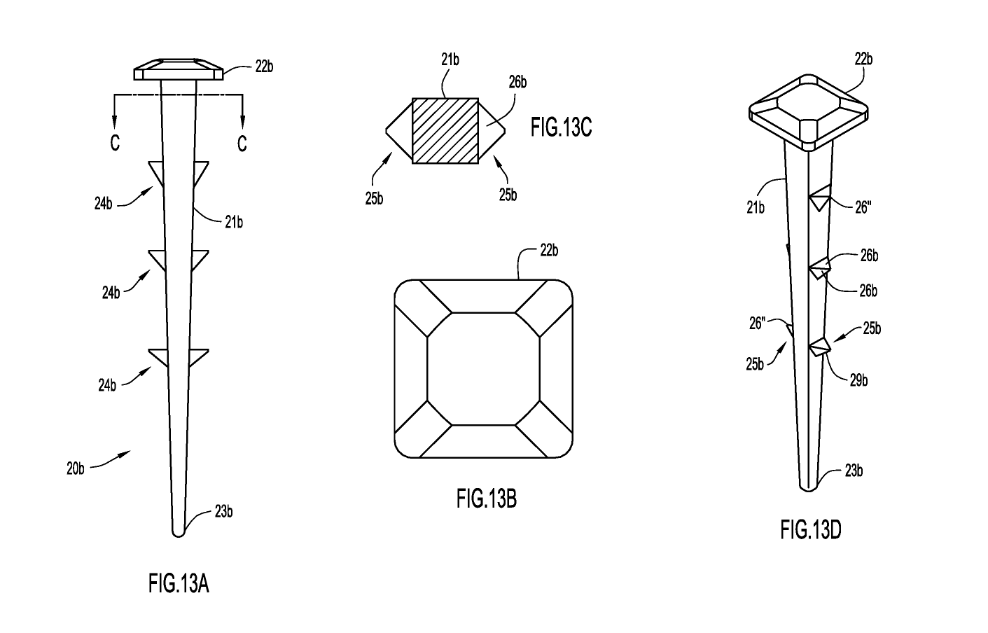

With reference to FIGS. 13A-13D, another alternative anchoring stake 20b for use with the beach towel 10 will now be described. Alternative anchoring stake 20b includes a generally elongated body 21b that is square in cross-section (FIG. 13C) and tapers axially from enlarged square head portion 22b (see FIG. 13A, as well as FIG. 13D) to a generally pointed opposite end 23b for ease of axial insertion of stake 20b through openings 11 into sand 100 (FIGS. 15A-15C). However, the generally pointed opposite end 23b may also be configured as a smoothly rounded end since rounded ends are less likely to hurt or injure a user (beachgoer). In addition, alternative anchoring stake 20b includes multiple axially spaced apart projections 24b comprising a pair of opposed generally squat triangularly pyramidal shaped spikes 25b each extending transverse to and outwardly from opposite planar outer surfaces of elongated body 21b (FIG. 13D). As may be seen by comparing FIGS. 13C-13D with FIGS. 12C-12D, spikes 25b are shorter and thicker than triangularly shaped spikes 24a. Further, each spike 25b has three slightly wider triangularly shaped flat outer faces 26b (only two shown in FIG. 12D) which merge to a pointed outer end 26″. One of the wider triangularly shaped outer faces 26b is oriented to face upward (i.e., toward the underside of enlarged head 22b), while each of the two other wider triangularly shaped outer faces 26b are inclined downwardly from an edge of the one outer face to form a downwardly facing edge 29b. Moreover, each outwardly extending spike 25b has a width dimension at its base which varies with the width dimension of the generally tapering elongated body 21b, but is usually slightly less than the width dimension of the planar outer surface of the generally square tapering elongated body 21b at its respective axial location (see FIG. 13D).

As described previously with respect to spike 20a, each spike 24b is designed such that the inclined outer faces 26b, as well as the downwardly facing edge 29b, permit stake 20b to be easily inserted axially into sand 100 by pressing (pushing) down with the palm of a hand, while the flat, triangularly shaped outer face 26b oriented toward the underside of enlarged head 22b enhances anchoring and securement of the stakes to the sand by resisting inadvertent upward movement or pulling out of the stakes from the sand. Also, as mentioned previously, each stake 20b is designed such that projections 24b have a maximum length dimension extending between the pointed outer ends 26″ of spikes 25b that is less than the length dimension of slit openings 11 in beach towel 10 so projections 24b may be aligned with the slit openings and easily passed therethrough into sand 100 during insertion of the stake for anchoring the beach towel in place.

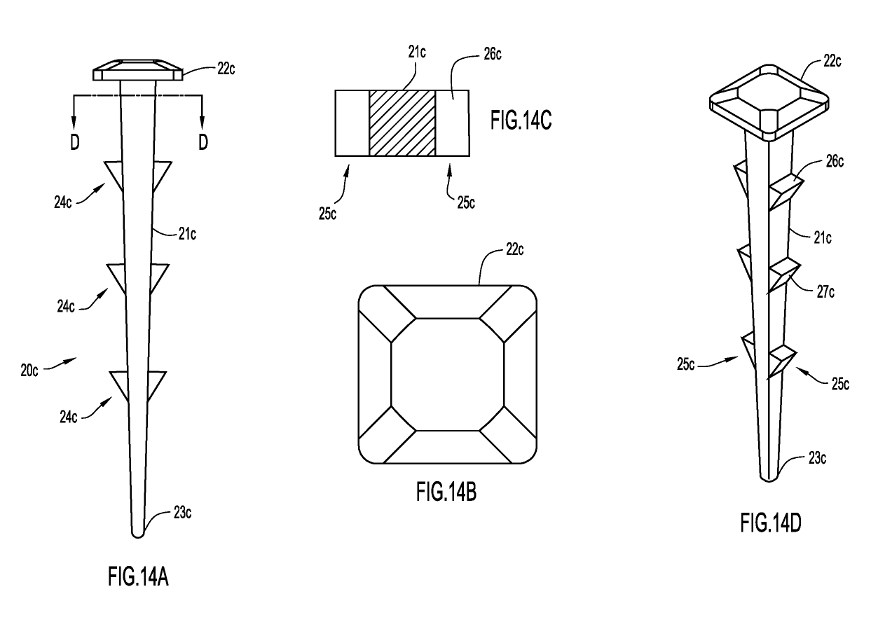

With reference to FIGS. 14A-14D, a further alternative anchoring stake 20c for use with the beach towel 10 of the present invention is shown. In this modification, anchoring stake 20c has a generally elongated body 21c that is square in cross-section (FIG. 14C) and tapers axially from enlarged square head 22c (see FIG. 14B, as well as FIG. 14D) to a generally pointed opposite end 23c for ease of axial insertion of stake 20c through openings 11 into sand 100. However, the generally pointed opposite end 23c may be configured as a smoothly rounded end since rounded ends are less likely to injure a user (beachgoer). In addition, alternative anchoring stake 20c includes multiple axially spaced apart projections 24c comprising a pair of opposed generally wedge-shaped protuberances 25c each extending transverse to and outwardly from opposite planar outer surfaces of elongated body 21c (see FIG. 14A, as well as FIGS. 14C-14D). Similar to flange-like protrusions 25, the generally wedge-shaped protuberances 25c have a top surface configured as a wide, flat shoulder 26c facing upward (i.e., toward the underside of the enlarged head portion 22c) and a flat outer surface 27c which gradually tapers or converges from an outmost edge of each shoulder to intersect with the planer outer surface of elongated body 21c. Moreover, each outwardly extending wedge-shaped protuberance 25c has a width dimension which varies with the width dimension of the generally axially tapering elongated body 21c, but is usually approximately the same width as the width of the planar outer surface of the generally square tapering elongated body 21b at its respective axial location (see FIGS. 14C-14D). Again, each protuberance 25c is designed such that flat, tapered outer surface 27c permits stake 20c to be easily inserted axially into sand 100 by pressing (pushing) down with the palm of a hand, while the wider, flat shoulder 26c provides enhanced anchoring and securement of the stake to the sand by resisting inadvertent upward movement or pulling out of the stake from the sand. Moreover, each projection 24c has a maximum length dimension between the outmost edges of opposed protuberances 25c which is less than the length dimension of slit openings 11 in beach towel 10 such that it may be aligned with a slit opening and easily passed therethrough into sand 100 during insertion of the stake for anchoring the beach towel in place.

As will now be further described, a user (e.g., a beachgoer) usually deploys the beach towel 10 of the present invention in the following manner. First, the beach towel is unfolded (or unrolled) by the user (beachgoer) from its storage/transport configuration (see, for example, FIG. 9) and positioned flat in a desired location on sand 100 (see FIG. 2). Next, the set of anchoring stakes 20 (or alternative anchoring stakes 20a, 20b or 20c) are removed from pouch 30. One anchoring stake is inserted through one of the slit openings 11 and pressed (pushed) downward with the palm of a hand until it is fully inserted (seated) into sand 100, as shown in FIGS. 15A-15C. Thereafter, the user (beachgoer) grasps the head 22 of fully seated stake 20 and twists it a quarter (¼) turn to lock the projections extending outward from the elongated body 21 of the stake into place in sand 100, as shown in FIG. 15C. Following that, the user inserts anchoring stakes 20 (or alternative anchoring stakes 20a, 20b or 20c) through the remaining slit openings 11 and repeats the seating and locking procedure.

Either before or after anchoring beach towel 10 to the sandy beach surface, pouch 30 is positioned adjacent a side edge 10b of beach towel 10 at one of its possible locations shown in FIG. 6 (e.g., adjacent a side or bottom edge) and attached to a bottom side of the beach towel using buttons 19 which may be inserted into slit openings (e.g., buttonholes) 36 on the rear side of the pouch, as shown in FIG. 4. However, pouch 30 may alternatively be attached to bottom side of beach towel 10 with small patches of hook-and-loop-type material (Velcro®), snaps or buckle-type clasps, as previously discussed.

If personal effects such as keys, cell phones, cash, credit/debit cards, identification, and other small items are to be stored, they are placed into pouch 30, as represented by the cell phone and key shown in phantom in FIG. 8. The pouch can be positioned on top of beach towel 10 for easy access to personal effects or underneath the beach towel to make it less visible to passers-by to prevent theft of personal items. If a portable solar powered cell phone/electronic device charging apparatus 40 with its power cable 42 is stored in pouch 30, it can be removed and positioned in an area on the top surface of beach towel 10 to receive solar energy emitted by the sun for charging a cell phone/electronic device while the cell phone/electronic device is stowed in the pouch for safe keeping, as further shown in phantom in FIG. 8.

As discussed previously, to pack beach towel 10 for transport after use, the personal effects such as keys and cell phones are removed from pouch 30, the stakes 20 are pulled from the sand and stored in the pouch. If included, cell phone/electronic device charging apparatus 40 with its power cable 43 is stored in the pouch as well, then the pouch is installed at one of the specified locations (shown in FIG. 6) and the beach towel rolled or folded into its storage/transport configuration (see, for example, FIG. 9 which illustrates a folded storage/transport configuration).

The components of the beach towel of the present invention described above may be available individually, or may be packaged as a kit 60, as illustrated in FIG. 16. Typically, the kit includes beach towel 10; a set of stakes 20 prepackaged within a transparent wrapping 80, e.g., a plastic bag or cellophane; a storage pouch 30; and a set of instructions 70. In addition, kit 60 may include optional solar powered cell phone/electronic device charging apparatus 40 to convent solar energy into electrical power to charge cell phones or other electronic devices brought to a beach or similar location by a user (beachgoer).

Further, the instruction sheet 70 may include written instructions, as well as pictorial representations, for inserting anchoring stakes 20 (or alternative anchoring stakes 20a, 20b or 20c) through holes 11 of beach towel 10 and into a sandy beach surface to securely hold the beach towel firmly to the sand. Optionally, the instruction sheet may include written instructions for storing stakes 20 (or alternative anchoring stakes 20a, 20b or 20c), the personal effects of users (beachgoers), and optional cell phone/electronic charging device apparatus 40 securely in storage pouch 30; attaching the storage pouch securely out of sight to the bottom (underside) of beach towel 10; and charging cell phones and/or other electronic devices with the optional solar powered charging apparatus 40 while each is stored in the storage pouch.

Although anchoring a beach towel to sand has been described, it should be appreciated that the beach towel stake herein described is also suitable for anchoring a wide variety of objects to soft earth, such as blankets, tarpaulins, and tents. Further, a wide variety of enlarged head shapes may be used instead of the specific square shape described. For example, it is envisioned that the enlarged head of the stake may be round, rectangular or oval, as well as any other decorative shape such as, for example, a seashell, a flower, or the like.

The foregoing descriptions of specific embodiments of the beach towel, anchoring stakes, storage pouch, and optional cell phone/electronic device charging apparatus of the present invention have been presented for purposes of illustration and description. They are not intended to be exhaustive or to limit the invention and method of use to the precise forms disclosed. Obviously many modifications and variations are possible in light of the above teachings. The embodiments were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstances may suggest or render expedient, but is intended to cover the application or implementation without departing from the spirit or scope of the claims of the present invention. Although specific terms are employed herein, they are used in a generic and descriptive sense only and not for purposes of limitation.

What is claimed is:

1. A beach towel in combination with a storage pouch comprising:
a beach towel of fabric material having a predetermined shape and size, said towel having a top surface, a bottom surface, an outer periphery and plural apertures extending through the fabric material proximate the periphery; and
a storage pouch of fabric material for storing a set of anchoring stakes when not deployed to secure the beach towel on a sand surface and for temporarily storing personal effects of a beachgoer when said anchoring stakes are deployed to secure the beach towel on said sand surface, said storage pouch having a front side, a rear side, an upper edge and an interior;
wherein said beach towel includes attachment means on its bottom surface at locations along the outer periphery to secure said storage pouch, and
wherein said storage pouch includes a fastening mechanism on its rear side adjacent said upper edge which cooperates with said attachment means to removably secure said pouch to the bottom surface of said beach towel.

2. The towel-pouch combination of claim 1,
wherein said attachment means comprises a pair of spaced apart buttons sewn to the bottom surface at locations set back a distance from said outer periphery, and
wherein said fastening mechanism comprises a pair of spaced apart narrow slit openings set back a distance from said upper edge which extend through the rear side of said pouch into its interior.

3. The towel-pouch combination of claim 2,
wherein the distance each slit opening is set back from said upper edge is equal to or less than the distance said buttons are set back from said outer periphery to provide secure containment and protection of personal effects out of sight of passers-by.

4. The towel-pouch combination of claim 1,
wherein the front panel of said storage pouch includes an opening to provide access to the interior of said pouch,
wherein said front panel further includes a closure member for selectively opening and closing said opening, and
wherein said pouch is fabricated from a flexible fabric material having a soft synthetic side and a waterproof side.

5. The towel-pouch combination of claim 1,
wherein the apertures defined through said beach towel are elongated slits having a buttonhole configuration formed through the fabric material of the beach towel, and
wherein the fabric material adjacent each said elongated slit is reinforced by stitching to strengthen the slit and prevent the fabric material from tearing.

6. The towel-pouch combination of claim 1, further comprising a set of anchoring stakes storable in said storage pouch when not deployed to secure the beach towel on the sand surface,
wherein each anchoring stake comprises an elongated tapered body having an enlarged head at one end, a generally pointed opposite end, and multiple axially spaced projections secured to an outer surface of the elongated tapered body between said ends, and
wherein said axially spaced projections are configured to be inserted through said apertures into sand beneath said beach towel to positively resist inadvertent pulling out of said anchoring stake from the sand.

7. The towel-pouch combination of claim 6,
wherein said elongated tapered body has a circular or square configuration in cross-section, and
wherein said multiple axially spaced projections are selected from the group consisting of a projection configured as a downwardly tapering solid trapezoid including a pair of diametrically 180° opposed generally flange-like protrusions, a projection including a pair of diametrically opposed generally triangular pyramidal shaped teeth, a projection including a pair of opposed generally squat triangularly pyramidal shaped spikes, and a projection including a pair of opposed generally wedge-shaped protuberances.

8. The towel-pouch combination of claim 1, further comprising a portable electronic device charging apparatus capable of recharging batteries of cell phones and other portable electronic devices, said apparatus being storable in said storage pouch when said stakes are deployed to secure the beach towel on the sand surface,
wherein said charging device comprises a solar charging assembly having an array of solar cells which receives solar energy and converts it into stored voltage to provide electrical power.

9. The towel-pouch combination of claim 8, wherein said charging apparatus includes at least one power cable for electrically connecting said solar charging assembly to a cell phone or a portable electronic device stored in said storage pouch, and
wherein said storage pouch has a closable opening to permit said at least one power cable to be connected to a cell phone or a portable electronic device while it is stored in said storage pouch and the storage pouch is secured to the bottom surface of said beach towel.

10. The towel-pouch combination of claim 2, further including a set of anchoring stakes stored in said storage pouch,
wherein the predetermined shape is a rectangular shape having a long side edge and said storage pouch including said stored set of anchoring stakes is removably attached adjacent said long side edge, and
wherein attachment of said storage pouch adjacent side long side edge permits the beach towel to be folded-up into a square or rectangular storage/transport configuration, stored in a carrying case, and transported to and from the sand surface.

11. An anchoring stake for securing a beach towel having an outer periphery and at least one aperture formed therein adjacent said outer periphery, said stake comprising:
an enlarged head including an upper side and an underside,
an elongated body having opposed ends and a circular or square configuration in cross-section, wherein said elongated body is attached at one end to the underside and tapers axially therefrom to a generally pointed opposite end; and
multiple axially spaced apart projections secured to an outer surface of said elongated body to facilitate securement of said stake in sand, and
wherein said enlarged head extends transversely outward from said elongated body to hold and stabilize said beach towel against a sand surface when said anchoring stake is inserted through said aperture into the sand by pressing downward on its upper side until its underside engages the beach towel.

12. The anchoring stake of claim 11,
wherein said multiple axially spaced apart projections are selected from the group consisting of a projection configured as a downwardly tapering solid trapezoid including a pair of diametrically 180° opposed generally flange-like protrusions, a projection including a pair of diametrically opposed generally triangular pyramidal shaped teeth, a projection including a pair of opposed generally squat triangularly pyramidal shaped spikes, and a projection including a pair of opposed generally wedge-shaped protuberances.

13. The anchoring stake of claim 11,
wherein said axially tapered elongated body has a circular configuration in cross-section and each multiple projection is configured as a downwardly tapering solid trapezoid including a pair of diametrically 180° opposed generally flange-like protrusions extending transverse to and perpendicularly outwardly from said outer surface,
wherein each of said generally flange-like protrusions has a top surface configured as a wide, flat shoulder facing upward toward the underside of the enlarged head and an outer surface which gradually tapers from an outmost edge of each shoulder to intersect with the outer surface of the elongated body, and
wherein each tapered outer surface cooperating to permit said stake to be readily inserted into the sand and each shoulder cooperating to resist withdrawal of the stake from the sand during use.

14. The anchoring stake of claim 11,
wherein said axially tapered elongated body has a circular configuration in cross-section and each multiple projection includes a pair of diametrically opposed generally triangular pyramidal shaped teeth extending transverse to and perpendicularly outwardly from said outer surface,
wherein each of said generally triangular pyramidal shaped teeth has three flat, triangularly shaped outer faces which merge to a pointed outer end, one of said outer faces being oriented to face upward toward the underside of said enlarged head and the other two outer faces being inclined downwardly from an outer edge of said one outer face to form a downwardly facing edge, and
wherein each inclined outer face and downwardly facing edge cooperating to permit said stake to be readily inserted into the sand and each upwardly oriented outer face cooperating to resist withdrawal of the stake from the sand during use.

15. The anchoring stake of claim 11,
wherein said axially tapered elongated body has a square configuration in cross-section and each multiple projection includes a pair of opposed generally squat triangular pyramidal shaped spikes extending transverse to and perpendicularly outwardly from said outer surface,
wherein each of said generally triangular pyramidal shaped spikes has three flat, triangularly shaped outer faces which merge to a pointed outer end, one of said outer faces being oriented to face upward toward the underside of said enlarged head and the other two outer faces being inclined downwardly from an outer edge of said one outer face to form a downwardly facing edge, and
wherein each inclined outer face and downwardly facing edge cooperating to permit said stake to be readily inserted into the sand and each upwardly oriented outer face cooperating to resist withdrawal of the stake from the sand during use.

16. The anchoring stake of claim 11,
wherein said axially tapered elongated body has a square configuration in cross-section and each multiple projection includes a pair of opposed generally wedge-shaped protuberances each extending transverse to and outwardly from opposite planar outer surfaces of the elongated body,
wherein each of said generally wedge-shaped protuberances has a top surface configured as a wide, flat shoulder facing upward toward the underside of the enlarged head portion and a flat outer surface which gradually tapers from an outmost edge of each shoulder to intersect with the planer outer surface of elongated body, and
wherein each tapered outer surface cooperating to permit said stake to be readily inserted into the sand and each shoulder cooperating to resist withdrawal of the stake from the sand during use.

17. A method of deploying a rectangular shaped beach towel of fabric material having an outer periphery and corners, a slit opening at each corner formed through the fabric material adjacent said outer periphery, and a storage pouch including a set of anchoring stakes as defined in claim 12 for holding the beach towel in sand, said method comprising:
transporting said beach towel to a sand surface in a folded storage/transport configuration;
unfolding said beach towel from its storage/transport configuration;
positioning said beach towel flat in a desired location on the sand,
removing said set of anchoring stakes from the storage pouch;
inserting one of the anchoring stakes of said set through one of the slit openings in a corner of said beach towel;
pressing axially downward on the head of said anchoring stake until the axially tapered elongated body is fully inserted into the sand; and
grasping the head of the anchoring stake and twisting it a quarter (¼) turn to lock the projections extending transverse to and perpendicularly outwardly from the outer surface of said axially tapered elongated body in place within the sand.

18. The method of claim 17, further comprising:
inserting another of said anchoring stakes of said set through each remaining slit opening in a corner of said beach towel;
pressing axially downward on the head of each another anchoring stake until the axially tapered elongated body is fully inserted into the sand; and
grasping the head of each another anchoring stake and twisting it a quarter (¼) turn to lock the projections extending transverse to and perpendicularly outwardly from the outer surface of said axially tapered elongated body into place within the sand.

19. The method of claim 17, further comprising:
storing personal effects of a beachgoer and, if included, a portable solar powered cell phone/electronic device charging apparatus in said storage pouch after removing said set of anchoring stakes from said storage pouch; and
positioning and attaching said storage pouch to a bottom surface of said beach towel adjacent its outer periphery for safekeeping of the personal effects and, if included, the charging apparatus out of sight of passers-by.

20. An anchorable beach towel kit, comprising:
a carrying case;
a folded beach towel of fabric material having an outer periphery and slit openings extending through the fabric material adjacent its outer periphery;
a set of anchoring stakes as defined in claim 12 prepackaged within a transparent wrapping and configured to be inserted through the slit openings of said beach towel into sand;
a storage pouch for removable attachment to a bottom surface of said beach towel adjacent its outer periphery;
an instruction sheet which includes written instructions and pictorial representations for inserting said anchoring stakes through the slit openings into the sand and locking each into place within the sand; and
optionally, a portable solar powered cell phone/electronic device charging apparatus for receiving solar energy and converting it into stored voltage to provide electrical power to charge a cell phone or other electronic device.
